(19) United States
(12) Patent Application Publication
(10) Pub. No.: US 2026/0170042 A1
(43) Pub. Date: Jun. 18, 2026

(54) TICKET CLASSIFICATION AND RESPONSE GENERATION

(71) Applicant: Walmart Apollo, LLC, Bentonville, AR (US)

(72) Inventors: Unni V.S., Bangalore (IN); Rahul Kumar Gupta, Bengaluru (IN); Rahul Kumar Mishra, Kasavanhalli (IN); Sowmyalakshmi KL, Egattur (IN); Suresh Kumar Shanmugam, Gunjur (IN); Vijayabaskaran Mannu, GKM Colony (IN); Pavithra Natarajan, Maraimalai Nagar (IN); Sujit Jos, Ernakulam (IN); Sowmya Hebbur Dayananda, Bangalore (IN); Satya Narayan, Bangalore (IN)

(21) Appl. No.: 19/369,514

(22) Filed: Oct. 27, 2025

Related U.S. Application Data
(60) Provisional application No. 63/735,006, filed on Dec. 17, 2024.

(51) Int. Cl. G06F 16/35; G06F 16/334; G06F 16/34; G06F 40/279

(52) U.S. Cl. CPC G06F 16/35; G06F 16/3344; G06F 16/3347; G06F 16/345; G06F 40/279

(57) ABSTRACT

Example implementations relate to automated ticket classification and response generation. In an example, historical tickets, each including at least one text field, are received, and an embedding model is applied to generate at least one embedding for each historical ticket. The historical tickets are clustered in a plurality of clusters. For each cluster, keywords are extracted from the text fields of each historical ticket in the cluster and a cluster-specific feature matrix is generated. A ticket is received, and at least one feature embedding is generated for the ticket. A similar cluster is determined for the ticket based on similarity between the at least one feature embedding for the ticket and the at least one cluster-specific feature embedding for each cluster in the plurality of clusters. A generative model is applied to generate one or more response steps based on historical response steps and to generate a response output.

### CROSS-REFERENCE TO RELATED APPLICATIONS

This application claims priority to U.S. Provisional Application No. 63/735,006 filed on Dec. 17, 2024 and entitled “Ticket Classification and Response Generation,” the disclosure of which is incorporated herein by reference in its entirety.

### TECHNICAL FIELD

This application relates generally to automated ticket management, and, more particularly, to automated classification and response systems for ticket management.

### BACKGROUND

A ticketing system may receive a support ticket or incident ticket requesting assistance with resolving an issue or incident. Such systems require a member of the support team to manually analyze the ticket and attempt to identify one or more potential solutions for the ticket. Current systems rely on manual interpretation of tickets by team members and manual generation of potential resolutions.

### BRIEF DESCRIPTION OF THE DRAWINGS

Various examples will be described below with reference to the following figures.

FIG. 1 depicts an example system that provides ticket classification and response generation, in accordance with some embodiments.

FIG. 2 depicts an example system for similar ticket identification, in accordance with some embodiments.

FIG. 3 depicts an example system for problem recommendation, in accordance with some embodiments.

FIG. 4 depicts an example system for ticket resolution, in accordance with some embodiments.

FIG. 5 depicts an example method for generating a response to a current ticket based on similar historical tickets, in accordance with some embodiments.

FIG. 6 depicts an example system with a machine-readable medium that includes instructions to generate a response to a current ticket based on similar historical tickets, in accordance with some embodiments.

FIG. 7 depicts an example computer system that implements one or more of the disclosed processes, in accordance with some embodiments.

### DETAILED DESCRIPTION

Managing large volumes of support incidents for large network interfaces, such as Internet-based network interfaces, is a challenging task. Some current systems provide support management through a ticketing process in which a ticket (e.g., support ticket or incident ticket) is generated by a user and provided to a support team. A member of the support team manually analyzes the ticket and attempts to identify one or more potential solutions for the ticket from one or more varied support domains (e.g., one or more technical areas supported by the ticketing system).

Current systems rely on manual interpretation as tickets include unstructured data, including both machine-generated data and sparse or confusing free-form data (e.g., written narratives that omit information or are poorly written). Although some systems have been proposed that utilize trained mappings of historical incidents to identify potential solutions, these systems require certain specific fields to be included in a ticket and for the information within those fields to be provided in a structured, well-presented manner. In practice, these fields are often omitted or provided with inadequate and/or poorly written information.

The disclosed systems and methods provide automated identification (e.g., recommendation) of similar historical tickets to a current ticket to extract relevant problems and solutions from the similar historical tickets. The automated identification utilizes embeddings generated for a set of historical tickets and the current ticket to identify the similar historical tickets. In some instances, one or more representative historical tickets may be selected from the similar historical tickets that include problem descriptions that are similar to a problem description included in the current ticket. One or more solution (e.g., response) steps may be generated, for example by a generative AI, based on resolution steps included in similar historical tickets. The automated identification of similar historical tickets, subsequent identification of similar problems, and automated generation of response steps for the current incident ticket allows for automated processing of unstructured ticket data that may include inadequate or incomplete information without requiring manual classification or intervention.

In various embodiments, a system including a processor and a non-transitory memory that stores instructions is disclosed. The instructions, when executed, cause the processor to receive a set of historical tickets each including at least one text field, apply an embedding model to generate an embedding for the at least one text field of each historical ticket in the set of historical tickets, and cluster the set of historical tickets in a plurality of clusters. For each cluster of the plurality of clusters, the processor executes the instructions to extract a set of keywords from the at least one text field of each historical ticket in the cluster. The set of keywords includes a set of frequent words. The processor further executes the instructions to generate a cluster-specific feature matrix including an entry for each keyword in the set of keywords. Subsequently, the processor executes the instructions to receive a real-time ticket including at least one text field, generate a feature matrix for the real-time ticket, determine a similar cluster for the real-time ticket based on similarity between the feature matrix for the real-time ticket and the cluster-specific feature matrix for each cluster in the plurality of clusters, apply a generative model to generate a plurality of response steps for the real-time ticket based on response steps of each historical ticket in the similar cluster, and apply the generative model to generate a response output for the real-time ticket by grouping the plurality of response steps based on similarity.

In various embodiments, a computer-implemented method is disclosed. The computer-implemented method includes steps of receiving a set of historical tickets with each including at least one text field, applying an embedding model to generate an embedding for the at least one text field of each historical ticket in the set of historical tickets, and clustering the set of historical tickets in a plurality of clusters. For each cluster in the plurality of clusters, the computer-implemented method includes steps of extracting a set of keywords from the at least one text field of each historical ticket in the cluster. The set of keywords includes a set of frequent words. The computer-implemented method further includes a step of generating a cluster-specific feature matrix including an entry for each keyword in the set of keywords. Subsequently, a real-time ticket including at least one text field is received, a feature matrix is generated for the real-time ticket, a similar cluster for the real-time ticket is determined based on similarity between the feature matrix for the real-time ticket and the cluster-specific feature matrix for each cluster in the plurality of clusters, and a generative model is applied to generate a plurality of response steps for the real-time ticket based on response steps of each historical ticket in the similar cluster and to generate a response output for the real-time ticket by grouping the plurality of response steps based on similarity.

In various embodiments, a non-transitory, computer-readable medium having instructions stored thereon is disclosed. The instructions, when executed by a processor, cause a device to perform operations including receiving a real-time ticket including at least one text field, generating a feature matrix for the real-time ticket, determining a similar cluster of historical tickets for the real-time ticket based on similarity between the feature matrix for the real-time ticket and a cluster-specific feature matrix for each of a plurality of clusters of historical tickets, and applying a generative model to generate a plurality of response steps for the real-time ticket based on response steps of each historical ticket in the similar cluster of historical tickets and to generate a response output for the real-time ticket by grouping the plurality of response steps based on similarity.

This description of the example embodiments is intended to be read in connection with the accompanying drawings that are to be considered part of the entire written description. Terms concerning data connections, coupling and the like, such as “connected,” “interconnected,” and/or “in signal communication with,” refer to a relationship wherein systems or elements are electrically connected (e.g., wired or wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems, as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Embodiments are described with respect to methods and systems for ticket classification and resolution generation. In some embodiments, a set of historical tickets is used to generate a set of clusters that correspond to specific incidents, issues, or other support requests represented in the set of historical tickets. Each of the historical tickets includes at least one text field. An embedding may be generated based on the at least one text field for each historical ticket. The historical tickets may be clustered, for example by applying a clustering model, based on the generated embeddings. For each cluster of historical tickets, one or more keywords may be extracted from the text fields of the historical tickets in the cluster and a cluster-specific feature matrix may be generated based on the one or more keywords for the corresponding cluster.

Subsequent to generating the cluster-specific feature matrix, a ticket, e.g., a real-time or current ticket, is received and a feature matrix is generated for the current ticket based on one or more text fields of the current ticket. A similar cluster (e.g., a most similar cluster) in the plurality of historical ticket clusters is determined by comparing the feature matrix of the current ticket to the cluster-specific feature matrix of each cluster in the plurality of historical ticket clusters. In response to identifying a similar cluster, a generative model produces one or more response steps for potentially resolving the problem of the current ticket. The generative model may identify one or more response steps that were successfully implemented for one or more historical tickets in the similar cluster and group the response steps based on similarity. The grouped response steps may be provided as a response to the current ticket.

In some embodiments, systems and methods for incident ticket classification and resolution generation include one or more trained generative models. The trained generative models may include one or more generative models, such as a first generative model that summarizes text fields of tickets (e.g., historical tickets or a current ticket) and a second generative model that identifies response steps in historical tickets and outputs a set of grouped response steps for a current ticket. Each of the generative models may include any suitable generative structure, such as a large language model (LLM) that is fine-tuned for one or more specific tasks (e.g., summarization, response extraction and grouping). Although specific embodiments are discussed herein, it will be appreciated that any suitable generative model structure may be used for the disclosed generative models.

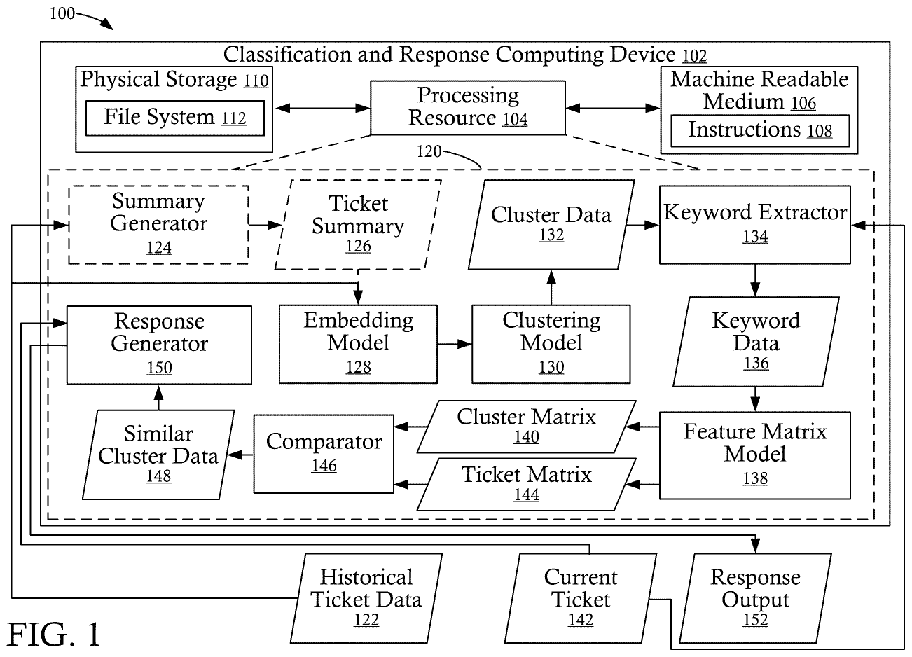

FIG. 1 depicts an example system 100 that provides ticket classification and response generation, in accordance with some embodiments. The system 100 includes a classification and response computing device 102 that classifies received tickets (e.g., support tickets or incident tickets) and generates a response output that includes one or more response steps that were successful for resolving one or more similar problems included in historical tickets. The classification and response computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The classification and response computing device 102 includes a non-transitory, machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (e.g., programming or software code) stored on machine-readable medium 106 to perform functions of the classification and response computing device 102, such as generating one or more clusters of historical tickets each including a cluster-specific feature matrix, generating a feature matrix for a current ticket, identifying a similar ticket for the current ticket, and generating a response output that includes one or more response steps. The instructions 108 may include instructions for implementing one or more models. In some embodiments, and as will be described further below herein, the classification and response computing device 102 may execute one or more models, processes, or algorithms, such as one or more generative models, to generate summaries of historical or received tickets and/or generate a response output including previously successful response steps for one or more historically similar tickets.

The classification and response computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the classification and response computing device 102. In some implementations, physical storage 110 may be accessed as a block storage device.

In some cases, the classification and response computing device 102 may also include a local file system 112 that may be implemented as a layer on top of the physical storage 110. For example, an operating system may be executing on the classification and response computing device 102 (by virtue of the processing resource 104 executing certain instructions 108 related to the operating system) and the operating system may provide the local file system 112 to store data on the physical storage 110.

The classification and response computing device 102 may be in communication with one or more additional devices over one or more network channels. For example, in various embodiments, the classification and response computing device 102 may be in communication with a web server, a cloud-based engine including one or more processing devices that may be provisioned for use, a database, a workstation, and/or any other suitable system or device. The classification and response computing device 102 may similarly be in communication, either directly or indirectly, with one or more user computing devices operatively coupled over the network. The other computing systems may be similar to the classification and response computing device 102, and may each include at least a processing resource and a machine-readable medium.

The classification and response computing device 102, e.g., a processing resource 104 of the classification and response computing device 102, implements or executes a ticket classification and response generation process 120 to classify tickets (e.g., incident tickets or support tickets) and provide response outputs including one or more steps for resolving the corresponding ticket based on historical tickets and historical responses. In some embodiments, historical ticket data 122 (e.g., data representative of one or more tickets previously received by one or more systems, such as a previously implemented manual system and/or previously implemented automated systems) is received by the ticket classification and response generation process 120, for example, by a summary generator 124. The historical ticket data 122 includes one or more historical tickets that each include one or more text fields (e.g., title, incident description, follow-up, transcripts of support conversations, or resolution). Each of the included text fields may include free-form or structured text, markup or other coding, or any other suitable input.

The summary generator 124 receives the historical ticket data 122 and generates a ticket summary 126 of each historical ticket in the historical ticket data 122. The ticket summary 126 may include a machine-generated summary of one or more of the included text fields. For example, a ticket summary 126 may summarize information found in all of the included text fields or a subset of the included text fields. The ticket summary 126 may be provided in a text form or machine-readable form. In some embodiments, the summary generator 124 is omitted and ticket summaries 126 are not generated for the historical ticket data 122. The summary generator 124 may include a generative model, such as an LLM fine-tuned for generation of ticket summaries.

The historical ticket data 122, and optionally the ticket summaries 126, are provided to an embedding model 128 that generates one or more embeddings for each historical ticket in the historical ticket data 122. The generated embeddings may be generated from one or more text fields included in each of the historical tickets, such as text fields related to descriptions of the incident or event that initiated the ticket. In some embodiments, the embeddings are generated from the ticket summaries 126. The embedding model 128 may include any suitable embedding model, such as an LLM-based embedding model, a neural-network based embedding model, etc.

In some embodiments, the embedding model 128 generates an embedding for a corresponding historical ticket by generating two or more embeddings for the historical ticket and concatenating the generated embeddings. For example, the embedding model 128 may generate an embedding for a description of an incident obtained from the historical ticket data 122 (e.g., a description embedding) and an embedding for a ticket summary 126 for the corresponding historical ticket (e.g., a summary embedding). The embedding model 128 may concatenate the description embedding and the summary embedding to generate a final output embedding for the corresponding historical ticket. In some embodiments, the generated embeddings include text embeddings having a predetermined number of dimensions, such as, for example, a text-embedding-ada-002 embedding.

The embeddings generated by the embedding model 128 may be provided to a clustering model 130 to generate cluster data 132 representative of sets (e.g., clusters) of similar historical tickets. The clustering model 130 may implement any suitable clustering process, such as a cosine similarity based process, to generate the cluster data 132. The clustering model 130 may operate on a single embedding, multiple embeddings, or a concatenated embedding for each corresponding historical ticket. The received embeddings may be normalized prior to being received by the clustering model 130 to enable a clustering process.

In some embodiments, the clustering model 130 identifies one or more representative historical tickets for each corresponding cluster of historical tickets. A representative historical ticket may include a historical ticket having the least distance (e.g., the highest similarity) to each of the other historical tickets in the corresponding cluster. In some embodiments, a representative historical ticket is selected based on a semantic comparison of a description and/or summary of each historical ticket in the corresponding cluster. In some embodiments, the selection of representative historical tickets may be omitted and each historical ticket in a cluster may be considered a representative historical ticket.

In some embodiments, in response to generating a plurality of clusters of the historical tickets, a keyword extractor 134 extracts one or more keywords from one or more historical tickets in each cluster. For example, keywords may be extracted from representative historical tickets for the corresponding cluster or from each historical ticket in a corresponding cluster. The one or more keywords may include one or more most frequent words included in historical tickets or representative historical tickets of the corresponding cluster.

In some embodiments, the keyword extractor 134 preprocesses portions of each historical ticket prior to extraction of the one or more keywords. For example, the keyword extractor 134 may implement data preprocessing to remove numeric values, stop words, or otherwise prepare free-form text found in one or more text fields of the corresponding historical tickets for keyword extraction. In some embodiments, the historical ticket data 122 may be preprocessed (e.g., precleaned) and preprocessing of the historical tickets may be omitted by the keyword extractor 134.

The keyword extractor 134 may identify up to a predetermined quantity of keywords. For example, the keyword extractor 134 may extract the top K most frequent words (where K is an integer greater than zero) as a set of K keywords. The keyword extractor 134 may implement a simple count of words to identify the most frequent words and/or may apply semantic comparisons to identify most frequent words representative of a group of similar words that occur in one or more historical tickets.

The keyword extractor 134 generates keyword data 136 for the one or more historical tickets in a corresponding cluster, e.g., cluster-specific keyword data. The keyword data 136 is provided to a feature matrix model 138 that generates a cluster-specific feature matrix, e.g., cluster matrix 140, for the corresponding cluster-specific keyword data. The cluster matrix 140 is representative of features of the keywords extracted for the corresponding cluster of historical tickets.

In some embodiments, the feature matrix model 138 includes a bidirectional language representation from transformers (BERT) model. The BERT model receives the keyword data 136 for a corresponding cluster of historical tickets and generates a K×L matrix, where K is the quantity of keywords in the corresponding keyword data 136 and L is the quantity of dimensions in the output of the BERT model. The feature matrix model 138 generates a set of P matrices, where P is equal to the quantity of clusters generated by the clustering model 130 (e.g., the quantity of distinct problems included in the historical ticket data 122). In some embodiments, a cluster-specific feature matrix is generated for only a subset of the keywords included in the keyword data 136.

In response to receiving a new ticket, e.g., current ticket 142, the classification and response generation process 120 compares the current ticket 142 to the clusters of historical tickets to identify a most similar set of historical tickets. For example, current ticket 142 may be structured similarly to the historical ticket data 122 and may include one or more text fields including free-form text regarding the incident that prompted creation of the ticket. The current ticket 142 is provided to the keyword extractor 134, which may implement the same preprocessing and keyword extraction processes as used for processing of the historical ticket data 122. For example, the keyword extractor 134 may preprocess the current ticket 142 to remove numeric values, stop words, or otherwise prepare free-form text found in one or more text fields and may extract up to the predetermined quantity of keywords from the current ticket 142 to generate keyword data 136, e.g., current ticket keyword data.

The current ticket keyword data is provided to the feature matrix model 138, which generates a ticket feature matrix, e.g., ticket matrix 144. The ticket matrix 144 includes feature embeddings for one or more keywords in the current ticket keyword data. The ticket matrix 144 may be generated using the same or a similar process as used to generate each of the cluster matrices 140 for each cluster. For example, the keyword data 136 for the current ticket may be provided to a BERT model to generate a K×L matrix for the current ticket 142.

A comparator 146 compares the ticket matrix 144 to each cluster matrix 140 for each cluster of historical tickets in the cluster data 132 to identify a similar cluster for the current ticket 142. The comparator 146 may use any suitable comparison process, such as a cosine similarity process to identify a cluster matrix 140 having the highest similarity (e.g., most similar) to the ticket matrix 144. In some embodiments, a cosine similarity process is applied on a row-by-row basis between the feature embedding of each keyword in the ticket matrix 144 and the feature embedding of each keyword in the cluster matrix 140 for each cluster. In response to the comparison process having a predetermined value, e.g., a value of one for a cosine similarity process, a match between a keyword in the ticket matrix 144 and a keyword in a corresponding cluster matrix 140 is determined.

In some embodiments, a similarity matrix S of size M×N may be determined for each cluster matrix 140, where M is the quantity of keywords in the ticket matrix 144 and N is the quantity of keywords in the corresponding cluster matrix 140. An element Sᵢⱼ of the similarity matrix represents the similarity between the i-th keyword in the ticket matrix 144 and the j-th keyword in the corresponding cluster matrix 140. To determine a similar cluster, e.g., to identify a cluster matrix 140 having the highest similarity to the ticket matrix 144, a maximum value for each row in the corresponding similarity matrix S is determined (indicating the maximum match between two keywords), resulting in a vector of M cosine similarities. The vector having the highest average corresponds to the cluster of historical tickets having the highest similarity to the current ticket 142.

After identifying a most similar cluster for the current ticket 142, the historical ticket data for the most similar cluster, e.g., similar cluster data 148, is provided to a response generator 150 to generate an incident response. The response generator 150 receives the similar cluster data 148 and extracts a set of response steps for the current ticket 142 based on successful response steps included in or associated with the historical tickets of the similar cluster data 148. For example, in some embodiments, the similar cluster data 148 includes a set of similar historical tickets that were successfully resolved and that include the resolution steps that were executed to resolve the corresponding ticket. The response generator 150 may extract the response steps for one or more of the historical tickets in the similar cluster data 148 (e.g., representative tickets in the similar cluster or all tickets in the similar cluster). The extracted response steps may include one or more response steps for addressing the incident identified in the current ticket.

The response generator 150 may generate a response output 152 (e.g., a solution or mitigation instructions) for the current ticket 142 by grouping each of the extracted response steps based on similarity. The response generator 150 may group extracted response steps based on semantic similarity, presentation order in historical tickets, and/or any other suitable grouping. The grouped response steps may be presented as one or more action plans in the response output 152. For example, in some embodiments, extracted responses may be grouped based on semantic similarity (e.g., a first set of responses steps reciting “restart program,” “close program and re-open”; and a second set of responses steps reciting “restart the computer,” “implement a restart,” and “reset the system” may each be grouped as semantically similar concepts) and subsequently presented in an order based on the average or mean position of the semantically similar response steps in the historical tickets (e.g., continuing the prior example, an output response step corresponding to closing the programs, which may be commonly presented first in the historical tickets, may be presented as a first step in an action plan; and resetting the computer, which may commonly be presented as a second response step in the historical tickets, will be presented as the second response step in the action plan).

In some embodiments, the response output 152 may include multiple sets of response steps or strategies. For example, although the set of historical tickets included in the similar cluster data 148 may have similar incidents (e.g., similar inciting incidents), the resolution of one or more historical tickets may be different as compared to the resolution of one or more other, co-grouped historical tickets. The response generator 150 may extract and group a first set of response steps and a second set of response steps. In some embodiments, the groups of response steps in the response output 152 may be presented in descending order from highest number of associated historical tickets to lowest number of associated historical tickets.

In some embodiments, the response output may include a synthesized action plan generated from one or more groupings of historical response steps. The synthesized action plan may be generated by creating one or more prompts for a generative model, e.g., an LLM, through zero-shot or few-shot learning approaches to output synthesized action plans, including response steps corresponding to the inciting incident of the current ticket 142. In some embodiments, grouping of historical response steps and/or generated summaries provides diversification of outputs, ensuring that a comprehensive set of solutions and recommendations is provided in response to a current ticket 142.

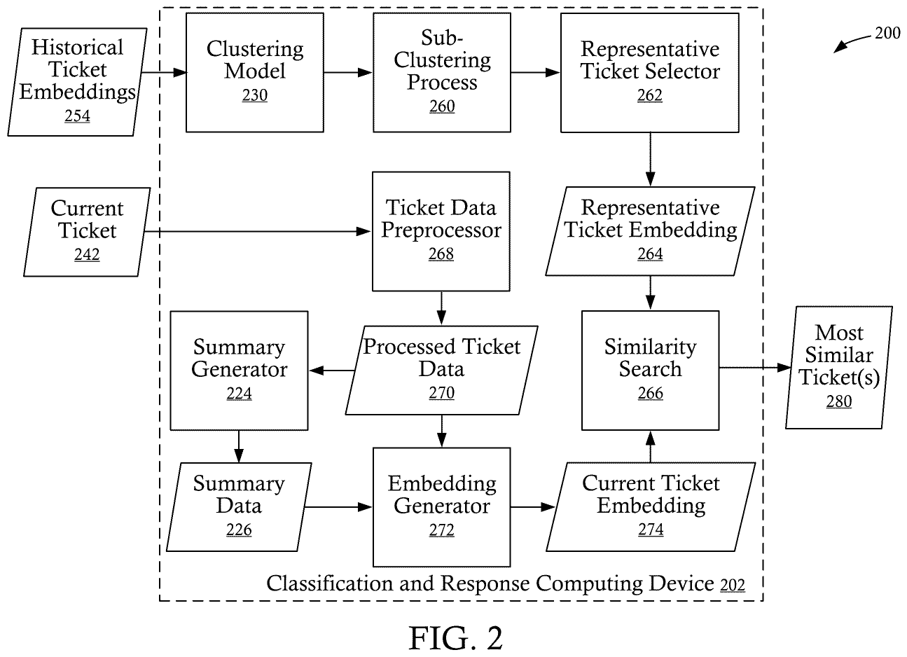

FIG. 2 depicts an example system 200 for similar ticket identification, in accordance with some embodiments. The system 200 includes a classification and response computing device 202, which is similar to the classification and response computing device 102 discussed above with respect to FIG. 1, and similar description is not repeated herein. In some embodiments, a processing resource of the classification and response computing device 202 implements a similar ticket identification process for identifying sets of historical tickets that are similar to a current ticket.

In some embodiments, historical ticket embeddings 254 are received by a clustering model 230. The historical ticket embeddings 254 may be generated according to any suitable process, such as by implementing the embedding model 128 discussed above with respect to FIG. 1. In some embodiments, the historical ticket embeddings 254 are generated by preprocessing historical tickets, extracting keywords from each of the historical tickets, extracting one or more features of each extracted keyword, and generating an embedding representative of a feature matrix of the features for each extracted keyword in a corresponding historical ticket.

The clustering model 230 generates clusters of historical tickets based on the received historical ticket embeddings 254. The clustering model 230 may provide an initial clustering of the historical ticket embeddings 254 to a sub-clustering process 260 that further refines clusters of historical tickets. For example, the sub-clustering process 260 may further cluster sets of historical tickets based on additional embeddings and/or text data included in the historical tickets. In some embodiments, the clustering model 230 and the sub-clustering process 260 may be incorporated into a single model or process.

Each generated cluster (or sub-cluster) of historical ticket embeddings is provided to a representative ticket selector 262 that selects one or more representative historical tickets. The representative ticket selector 262 may select one or more representative historical tickets using any suitable process, such as a semantic comparison process to identify a historical ticket having the highest similarity to the other historical tickets in a cluster. The selection process, e.g., a semantic comparison process, may be based on at least one embedding generated for each historical ticket in the corresponding cluster. In some embodiments, the representative ticket selector 262 outputs a corresponding representative ticket embedding 264, e.g., an embedding representative of a cluster-specific feature matrix or a representative ticket-specific feature matrix. The representative ticket embedding 264 may be provided to and used in a similarity search 266 discussed in greater detail below.

In some embodiments, a current ticket 242 is received by the classification and response computing device 202 and provided to a ticket data preprocessor 268 that removes numeric values or stop words, prepares (e.g., formats) free-form text found in one or more text fields of the current ticket 242, and/or performs additional operations to prepare the current ticket 242 for additional processing. In some embodiments, the ticket data preprocessor 268 generates processed ticket data 270.

The processed ticket data 270 is, optionally, provided to a summary generator 224 to generate summary data 226 for the current ticket 242. The summary generator 224 and the corresponding summary data 226 are similar to the summary generator 124 and ticket summary 126, respectively, discussed above with respect to FIG. 1. The summary generator 224 may generate summary data 226 for each field in a current ticket 242 and/or may generate a summary for a subset of the fields in the current ticket 242.

The processed ticket data 270, and, when present, the optionally generated summary data 226, are provided to an embedding generator 272 that generates a current ticket embedding 274 representative of the current ticket 242. The embedding generator 272 may include an embedding model that generates a current ticket embedding 274 having a similar format to the embeddings of the historical tickets included in the historical ticket embeddings 254. For example, the embedding generator 272 may implement the same or a similar embedding model as used to generate the historical ticket embeddings 254. The embedding generator 272 may implement one or more processes or models to perform keyword extraction and/or to generate an embedding, such as a feature matrix embedding, based on one or more extracted keywords. The generated current ticket embedding 274 is provided to the similarity search 266.

The similarity search 266 receives a representative ticket embedding 264 for each cluster in a set of clusters generated by the clustering model 230 and/or the sub-clustering process 260 and additionally receives a current ticket embedding 274. The received embeddings may include feature matrix embeddings representative of keyword matrices, for example, as received in the historical ticket embeddings 254 and/or generated by the embedding generator 272 for the current ticket 242.

In some embodiments, the similarity search 266 implements a cosine similarity process to generate a similarity matrix S of size M×N for each representative historical ticket embedding 264, where M is the quantity of keywords used to generate the current ticket embedding 274 and N is the quantity of keywords used to generate the representative ticket embedding 264. An element Sᵢⱼ of the similarity matrix represents the similarity between the i-th keyword of the current ticket and the j-th keyword in the corresponding representative ticket. To determine a similar representative ticket, a maximum value for each row in the corresponding similarity matrix S is determined (indicating the maximum match between two keywords), resulting in a vector of M cosine similarities. In some embodiments, the vector having the highest average corresponds to the representative ticket having the highest similarity to the current ticket 242.

The similarity search 266 performs similarity searching between the current ticket embedding and each of the representative ticket embeddings 264 to identify a most similar representative ticket embedding 264 and a corresponding most similar cluster of historical tickets. The identified one or more most similar tickets 280 may be output by the similarity search 266 for use in one or more additional processes, such as a response generation process. The most similar tickets 280 may include one or more representative tickets for the corresponding cluster or each ticket clustered in the corresponding cluster.

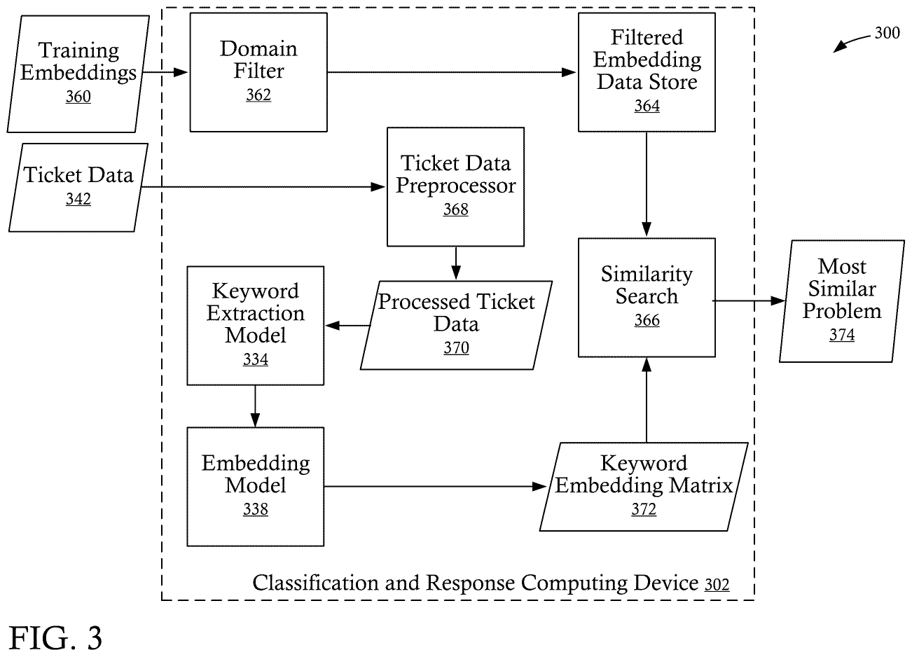

FIG. 3 depicts an example system 300 for problem recommendation, in accordance with some embodiments. The system 300 includes a classification and response computing device 302, which is similar to the classification and response computing device 102 discussed above with respect to FIG. 1, and similar description is not repeated herein. In some embodiments, a processing resource of the classification and response computing device 302 implements a similar problem identification process for clustering historical tickets that have similar problems, e.g., similar inciting incidents.

In some embodiments, a set of training embeddings 360 is received by a domain filter 362, which filters the set of training embeddings 360 based on domain-specific parameters, such as domain-specific keywords, domain-specific field values, etc. For example, in some embodiments, the set of training embeddings 360 represents a set of embeddings generated for a clustered set of historical tickets. The domain filter 362 selects historical tickets that include a similar problem defined by a first set of domain-specific parameters. The filtered, e.g., selected, embeddings may be provided to a filtered embedding data store 364 for retrieval during a similarity search 366, discussed in greater detail below.

In some embodiments, ticket data 342 is received for a ticket. The ticket data 342 may be representative of a current ticket or a historical ticket. The ticket data 342 is provided to a ticket data preprocessor 368 that removes numeric values or stop words, prepares (e.g., formats) free-form text found in one or more text fields of the ticket data 342, and/or performs additional operations to prepare the ticket data 342 for additional processing. In some embodiments, the data preprocessor 36 generates processed ticket data 370.

The preprocessed ticket data 370 is provided to a keyword extraction model 334 that extracts a set of keywords. The set of keywords may include the top K most frequent words (where K is an integer greater than zero). The keyword extraction model 334 may implement a simple count of words to identify the most frequent words and/or may apply semantic comparisons to identify most frequent words representative of a group of similar words that occur in the ticket data 342.

In some embodiments, the set of keywords is provided to an embedding model 338 to generate a keyword embedding matrix 372. The embedding model 338 may include any suitable embedding model, such as a BERT model. The generated keyword embedding matrix 382 may be a feature embedding matrix representative of features of each keyword in the set of keywords generated by the keyword extraction model 334.

In some embodiments, the keyword embedding matrix 372 is provided to the similarity search 366 to identify a most similar problem 374 within a set of historical tickets, for example, as represented by the set of embeddings in the filtered embedding data store 364. The similarity search 366 may implement a cosine similarity process to generate a similarity matrix S of size M×N for each embedding in the filtered embedding data store 364, where M is the quantity of keywords used to generate the keyword embedding matrix 372 and N is the quantity of keywords used to generate each of the training embeddings 360. An element Sᵢⱼ of the similarity matrix represents the similarity between the i-th keyword of the keyword embedding matrix 372 and the j-th keyword in the corresponding filtered embedding. To determine a similar problem, a maximum value for each row in the corresponding similarity matrix S is determined (indicating the maximum match between two keywords), resulting in a vector of M cosine similarities. The vector having the highest average corresponds to the problem (or ticket including a problem) having the highest similarity to the keyword embedding matrix 372.

In some embodiments, the system 300 may be utilized for clustering or sub-clustering of historical tickets. For example, the ticket data 342 may include a set of historical tickets that may each be associated with a most similar problem 374. Ticket data 342 that is associated with a first most similar problem 374 may be considered a cluster or sub-cluster of historical tickets. The ticket data 342 may correspond to a cluster of historical tickets generated by a separate clustering process, such as clustering model 130 discussed above with respect to FIG. 1.

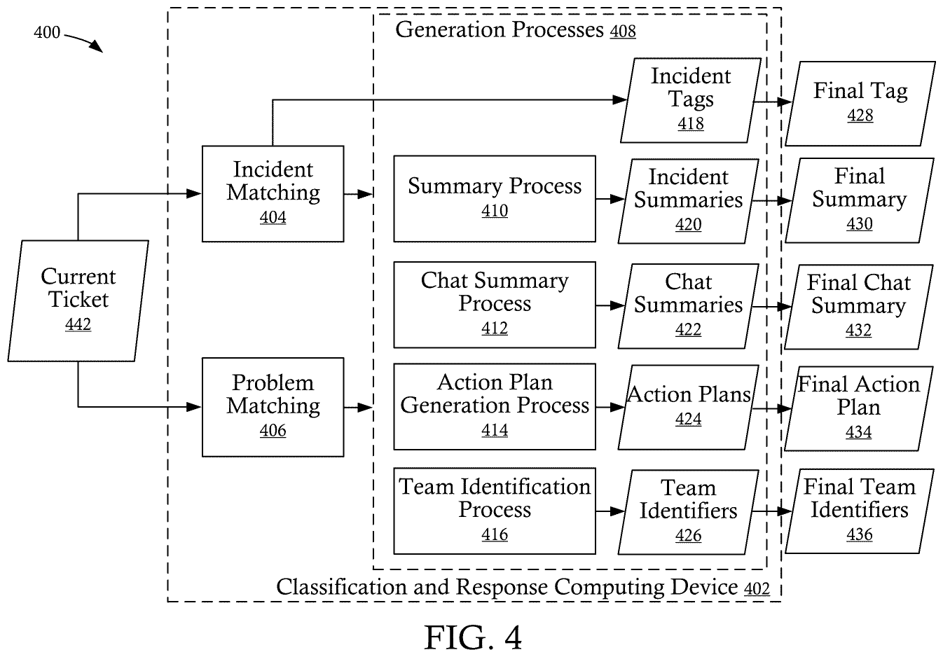

In some embodiments, the system 300 may be utilized for identifying one or more historical problem descriptions included in historical tickets that are similar to a problem description provided in a current ticket. The ticket data 342 may represent a current ticket that may include a problem description. The ticket data 342 is processed to generate a keyword embedding matrix 372 for the current ticket, which is compared to the filtered embeddings in the filtered embedding data store 364 by the similarity search 366 to select a most similar problem 374 to the problem description of the current ticket. A resolution, such as a resolution included in a historical ticket containing the most similar problem 374, may be obtained for use in response generation, as discussed in greater detail below with respect to FIG. 4.

FIG. 4 depicts an example system 400 for ticket resolution, in accordance with some embodiments. The system 400 includes a classification and response computing device 402, which is similar to the classification and response computing device 102 discussed above with respect to FIG. 1, and similar description is not repeated herein. In some embodiments, a processing resource of the classification and response computing device 402 implements a ticket resolution process.

A current ticket 442 is received by each of an incident matching process 404 and a problem matching process 406. The incident matching process 404 identifies a most similar representative historical ticket, for example, as discussed with respect to FIG. 2 above, and the problem matching process 406 identifies a most similar problem, for example, as discussed with respect to FIG. 3 above. Although incident matching process 404 and problem matching process 406 are similar, it will be appreciated that, in some embodiments, the incident matching process 404 generates one or more similar tickets based on multiple portions of historical tickets and the current ticket and the problem matching process 406 generates similar problems (e.g., tickets including similar problems) based on matches between problem descriptions in historical tickets and the current ticket 442.

The output of the incident matching process 404 and the problem matching process 406 are each provided to a set of generation processes 408 that generate a response to the current ticket 442. The generation processes 408 may include generative processes, such as LLMs or other generative models. The generation processes 408 may include a set of sub-processes implemented by the same or different models, such as a summary process 410, a chat summary process 412, an action plan generation process 414, and a team identification process 416. In some embodiments, the generation process 408 may extract one or more data elements, such as one or more incident tags 418, from a provided historical ticket, such as a most similar representative ticket provided by the incident matching process 404.

In some embodiments, a summary process 410 generates an incident summary for the current ticket 442 and/or historical tickets identified by either the incident matching process 404 or the problem matching process 406. The summary process 410 may generate a summary of the current incident that is compared to summaries of prior incidents to identify similar elements for resolution generation. After summarizing the current ticket 442, a final summary 430 may be generated. Grouping of the summaries 420 provides diversified results that include a comprehensive set of solutions and recommendations.

In some embodiments, a chat summary process 412 summarizes chats or other interactions that occurred between support teams and users during resolution of the current ticket 442 or prior tickets. The generated chat summaries 422 may be used for identifying common instructions provided by support personnel during resolution of prior, similar incidents. The chat summaries 422 may be used to synthesize a final chat summary 432 including instructions to be provided in a response output to the current ticket 442. Similar to grouping of the summaries 420, grouping of the chat summaries 422 provides diversified results that include a comprehensive set of solutions and recommendations.

In some embodiments, an action plan generation process 414 generates one or more action plans 424 for resolution of the current ticket 442. The one or more action plans 424 are synthesized from prior action plans or resolution steps that were performed during resolution of similar incidents or problems. A final action plan 434 may be synthesized from synthesized the grouped action plans 424 to identify common resolution steps. Final action plan 434 may include steps or tasks taken from multiple action plans 424 and presented in a selected order, such as a descending order by frequency of appearance of the corresponding step in the action plans 424.

In some embodiments, a team identification process 416 generates one or more team identifiers 426 that identify a corresponding support team that may be required for implementation of one or more response steps in a response output, e.g., a corresponding support team required for implementing one of the response steps in a final action plan 434 based on team access or control of corresponding system components. In some embodiments, different teams may be required for different response steps, and multiple team identifiers may be provided as a set of final team identifiers 436.

In some embodiments, the final tag(s) 428, final summary 430, final chat summary 432, final action plan 434, and final team identifier(s) 436 may be combined to generate a response output for the current ticket 442. The final tag(s) 428, final summary 430, final chat summary 432, final action plan 434, and final team identifier(s) 436 may be provided in a structured data format, e.g., through completion of a response template or other structured data element, or may be synthesized into a conversational response by a generative model, such as an LLM that implements the generative processes 408.

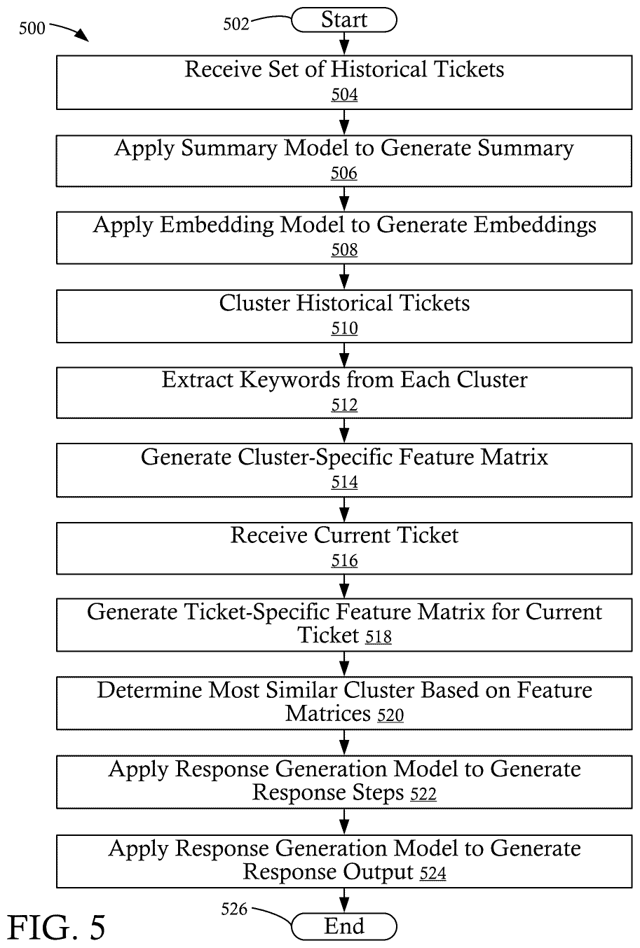

FIG. 5 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 5 may be implemented in the form of executable instructions stored on a machine-readable medium and executed by a processing resource and/or in the form of electronic circuitry. For example, aspects of the method may be described below as being performed by a response process, an example of which may be the classification and response generation process 120 running on a processing resource 104 of the classification and response computing device 102 described above. Additionally, other aspects of the method described below may be described with reference to other elements shown in FIG. 1 for non-limiting illustration purposes.

FIG. 5 depicts an example method 500 for generating a response to a current ticket based on similar historical tickets, in accordance with some embodiments. Method 500 starts at block 502 and continues to block 504, where a set of historical tickets is received. The set of historical tickets includes prior tickets (e.g., support tickets or incident tickets) that were submitted to a ticketing system and resolved through one or more manual and/or automated processes.

At block 506, a summary model is applied to generate a summary for each ticket in the set of historical tickets. The summary model may include a generative model that receives one or more text fields of a ticket, such as a historical ticket, and generates a summary of the received text fields. The generative model may include an LLM.

At block 508, an embedding model is applied to generate at least one embedding for each ticket in the set of historical tickets. The embedding model may include a keyword extractor that extracts one or more keywords from one or more text fields of a corresponding ticket and an embedding model, such as a BERT model, that generates an embedding or embedding matrix for the set of keywords extracted from the corresponding ticket.

At block 510, the historical tickets are clustered. For example, embeddings for each historical ticket in the set of tickets may be compared to generate two or more clusters of similar historical tickets. In some embodiments, a clustering process includes an initial clustering process and a sub-clustering process to further refine clusters of historical tickets.

At block 512, one or more keywords are extracted from each cluster (or sub-cluster) of historical tickets. The one or more keywords may be extracted from representative historical tickets for the corresponding cluster or from each historical ticket in a corresponding cluster. The one or more keywords may include one or more most frequent words included in historical tickets or representative historical tickets of the corresponding cluster. In some embodiments, a predetermined quantity of keywords may be extracted. For example, a set of the top K most frequent words (where K is an integer greater than zero) may be extracted for each corresponding cluster as a set of K keywords.

At block 514, a cluster-specific feature matrix is generated for each cluster. In some embodiments, a K×L matrix, where K is the quantity of keywords extracted from the corresponding cluster and L is the quantity of dimensions in the output of an embedding model, may be generated. A set of P cluster-specific feature matrices, where P is equal to the quantity of clusters, may be generated. In some embodiments, a cluster-specific feature matrix is generated for only a subset of the keywords associated with a cluster.

At block 516, a current ticket is received and, at block 518, a ticket-specific feature matrix is generated for the current ticket. The ticket-specific feature matrix may be generated using the same or a similar process as used for generating cluster-specific feature matrices for each cluster. For example, one or more keywords may be extracted from the current ticket and a K×L matrix may be generated for the current ticket including embeddings generated by the same embedding model as used for the cluster-specific feature matrices.

At block 520, a most similar cluster-specific feature matrix for the ticket-specific feature matrix is determined. The determination may be based on a cosine similarity between embeddings in the ticket-specific feature matrix and embeddings in each of the cluster-specific feature matrices. For example, a cosine similarity process may be applied on a row-by-row basis between the ticket-specific feature matrix and the cluster-specific feature matrix for each cluster. Matches between embeddings in the ticket-specific feature matrix and the cluster-specific feature matrices are determined and an average or total value is generated for each of the cluster-specific feature matrices. A most similar cluster-specific feature matrix may be selected based on the average or total similarity score for each cluster-specific feature matrix.

At block 522, a response generation model is applied to generate one or more response steps. The response generation model may include a generative model, such as an LLM. The one or more response steps are generated based on one or more historical response steps of each historical ticket in the most similar cluster. For example, the response generation model may identify response steps in a representative historical ticket for the most similar cluster or may identify common response steps in all tickets of the most similar cluster. The response generation model may extract or summarize the identified response steps to generate a set of synthesized response steps for mitigating or addressing a problem identified in the current ticket.

At block 524, the response generation model is applied to generate a response output. The response output may include grouped sets of response steps generated at block 522. For example, response steps may be grouped based on semantic similarity and subsequently presented in an order based on the average or mean position of the semantically similar response steps in one or more historical tickets. The response generation model may present the response steps using similar or identical language as used in the one or more historical tickets or may implement a generative process to generate a summary or restatement of the response steps. At block 526, the method 500 ends.

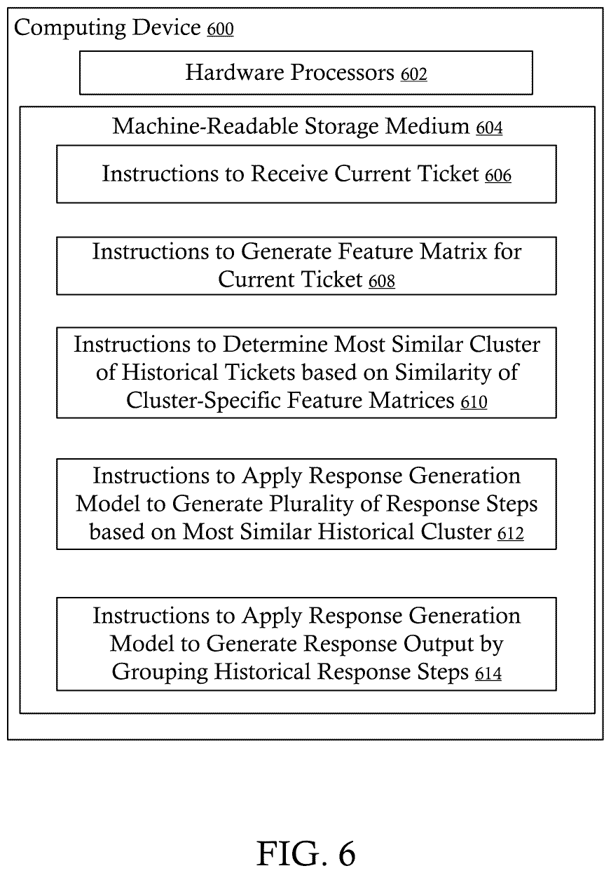

FIG. 6 depicts an example system with a machine-readable medium that includes instructions to generate a response to a current ticket based on similar historical tickets, in accordance with some embodiments. The machine-readable medium 604 may be encoded with example instructions executable by processing resource 602. In some implementations, the system 600 may be useful for implementing aspects of the systems 100, 200, 300, 400 of FIGS. 1-4 or performing the aspects of method 500 of FIG. 5. For example, the instructions encoded on machine-readable medium 604 may be included in instructions 108 of FIG. 1. In some implementations, functionality described with respect to FIG. 1 may be included in the instructions encoded on machine-readable medium 604.

The processing resource 602 may include a microcontroller, a microprocessor, central processing unit core(s), an ASIC, an FPGA, and/or other hardware device suitable for retrieval and/or execution of instructions from the machine-readable medium 604 to perform functions related to various examples. Additionally or alternatively, the processing resource 602 may include or be coupled to electronic circuitry or dedicated logic for performing some or all of the functionality of the instructions described herein. The machine-readable medium 604 may be any medium suitable for storing executable instructions, such as RAM, ROM, EEPROM, flash memory, a hard disk drive, an optical disc, or the like. In some example implementations, the machine-readable medium 604 may be a tangible, non-transitory medium. The machine-readable medium 604 may be disposed within the system 600 in which case the executable instructions may be deemed installed or embedded on the system. Alternatively, the machine-readable medium 604 may be a portable (e.g., external) storage medium and may be part of an installation package.

As described further herein below, the machine-readable medium 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 6.

The machine-readable medium 604 includes instructions 606-614. Instructions 606, when executed, cause the processing resource 602 to receive a current ticket. The current ticket may include an incident ticket, a support ticket, or any other suitable ticket. The ticket includes one or more free-form text fields, such as a description of an initiating incident (e.g., initiating problem) that led to generation of the ticket.

Instructions 608, when executed, cause the processing resource 602 to generate a feature matrix for the received current ticket (e.g., a ticket-specific feature matrix). The feature matrix may include a K×L matrix, where K is the quantity of keywords extracted from the corresponding cluster and L is the quantity of dimensions in the output of an embedding model applied to keywords of the current ticket. The keywords may be extracted from the current ticket using a keyword extraction process that extracts the top K most common words from the ticket as keywords.

Instructions 610, when executed, cause the processing resource 602 to determine a most similar cluster in a set of historical ticket clusters based on a similarity of the feature matrix for the current ticket and cluster-specific feature matrices for each cluster in the set of historical ticket clusters. The similarity may be determined by a cosine similarity process that applies a row-by-row comparison of embeddings in the feature matrix for the current ticket and the cluster-specific feature matrices for each cluster. The cluster-specific feature matrix having a highest average value for the row-by-row comparison is a most similar cluster.

Instructions 612, when executed, cause the processing resource 602 to apply a response generation model to generate a plurality of response steps based on the historical tickets in the most similar cluster. The response generation model may include a generative model, such as an LLM. The one or more response steps are generated based on one or more historical response steps of each historical ticket in the most similar cluster. For example, the response generation model may identify response steps in a representative historical ticket for the most similar cluster or may identify common response steps in tickets of the most similar cluster. The response generation model may extract or summarize the identified response steps to generate a set of synthesized response steps for mitigating or addressing a problem identified in the received current ticket.

Instructions 614, when executed, cause the processing resource 602 to apply the response generation model to generate a response output by grouping the response steps generated from the historical tickets. For example, response steps may be grouped based on semantic similarity and subsequently presented in an order based on the average or mean position of the semantically similar response steps in one or more historical tickets. The response generation model may present the response steps using similar or identical language as appears in the one or more historical tickets or may implement a generative process to generate a summary or restatement of the response steps.

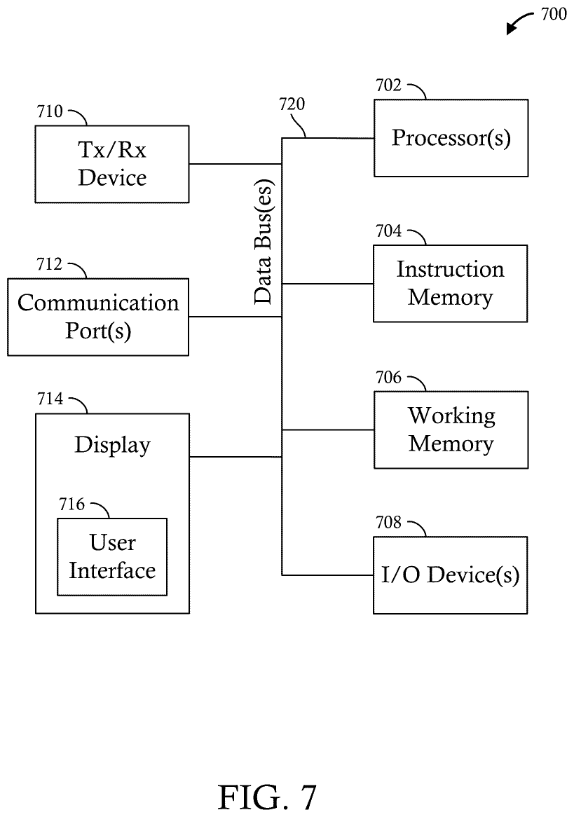

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication port(s) 712, display 714, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application-specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an application-specific integrated circuit (ASIC), a field programmable gate array (FPGA), a programmable logic device (PLD), etc.

In some embodiments, the one or more processing resources 702 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code stored on the instruction memory 704 embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM), such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), content addressable memory (CAM), polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for classifying a received ticket and generating a response output, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network. For example, if a communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network via the transceiver 710.

The communication port(s) 712 may include any suitable hardware, software, and/or combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine-learning model-training data.

In some embodiments, the communication port(s) 712 couple(s) the computing device 700 to a network. The network may include local area networks (LAN), as well as wide area networks (WAN), including, without limitation, Internet, wired channels, wireless channels, communication devices, including telephones, computers, wire, radio, optical and/or other electromagnetic channels, and combinations thereof, including other devices and/or components capable of or associated with communicating data. For example, the communication environments may include in-body communications, various devices, and various modes of communications such as wireless communications, wired communications, and combinations of the same.

In some embodiments, the transceiver 710 and/or the communication port(s) 712 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 714 may be any suitable display and may display the user interface 716. The user interfaces 716 may enable user interaction with a ticket generation or response system. For example, the user interface 716 may be a user interface for an application of a network environment operator that allows a user to view and interact with the operator's website. In some embodiments, a user may interact with the user interface 716 by engaging the input/output devices 708. In some embodiments, the display 714 may be a touchscreen, where the user interface 716 is displayed on the touchscreen.

The display 714 may include a screen such as, for example, a Liquid Crystal Display (LCD) screen, a light-emitting diode (LED) screen, an organic LED (OLED) screen, a movable display, a projection, etc. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted to autonomously carry out a function or set of functions. A module/engine may include a component or arrangement of components implemented using hardware, such as by an application-specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse, or touchscreen devices) that execute an operating system, system programs, and application programs, while also implementing the engine using multitasking, multithreading, distributed (e.g., cluster, peer-peer, or cloud) processing where appropriate, or other such techniques. Accordingly, each module/engine may be realized in a variety of physically realizable configurations and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more GPUs, one or more CPUs, and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

Although embodiments are illustrated herein including certain systems and/or devices, it will be appreciated that additional systems, servers, storage mechanism, etc., may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that automated classification of received tickets and generation of response outputs as disclosed herein, particularly on large datasets intended to be used in large network support systems, is only possible with the aid of computer-assisted machine-learning algorithms and techniques, such as the disclosed embedding models, clustering models, and LLMs. In some embodiments, machine-learning processes are used to perform operations that cannot be performed practically by a human, either mentally or with assistance, such as clustering of historical tickets, generation of keyword embeddings, identification of a most similar cluster, and generation of response outputs.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a plurality of historical tickets each including at least one text field;
apply an embedding model to generate an embedding for each historical ticket in the plurality of historical tickets;
cluster the plurality of historical tickets in a plurality of clusters;
for each cluster of the plurality of clusters:
extract one or more keywords from the at least one text field of each historical ticket in the cluster; and
generate at least one cluster-specific feature embedding including an entry for each of the one or more keywords;
receive a ticket;
generate at least one feature embedding for the ticket;
determine a similar cluster for the ticket based on similarity between the at least one feature embedding for the ticket and the at least one cluster-specific feature embedding for each cluster in the plurality of clusters;
apply a first generative model to generate one or more ticket response steps for the ticket based on one or more historical response steps of each historical ticket in the similar cluster; and
apply the first generative model to generate a response output for the ticket by grouping the one or more ticket response steps based on similarity.

2. The system of claim 1 wherein the instructions, when executed, cause the processor to:
apply a second generative model that summarizes the at least one text field of each historical ticket in the plurality of historical tickets; and
apply the embedding model to the summaries to generate the embedding for each historical ticket in the plurality of historical tickets.

3. The system of claim 1 wherein the instructions, when executed, cause the processor to:
extract at least one keyword from a text field of the ticket; and
generate the at least one feature embedding for the ticket based on the at least one keyword.

4. The system of claim 3 wherein the instructions, when executed, cause the processor to:
apply a feature matrix model to the at least one keyword to generate a ticket matrix, wherein the ticket matrix comprises the at least one feature embedding for the ticket;
apply the feature matrix model to the embedding for each historical ticket in the plurality of historical tickets to generate a corresponding cluster matrix, wherein each cluster matrix comprises the at least one cluster-specific feature embedding for each corresponding cluster in the plurality of clusters; and
determine the similar cluster for the ticket based on a comparison of the ticket matrix to the cluster matrix for each corresponding cluster in the plurality of clusters.

5. The system of claim 4 wherein the instructions, when executed, cause the processor to apply a similarity process to the ticket matrix and the cluster matrix for each corresponding cluster in the plurality of clusters to determine the similar cluster.

6. The system of claim 5 wherein the instructions, when executed, cause the processor to determine the similar cluster based on the similarity process having a predetermined value.

7. The system of claim 1 wherein the instructions, when executed, cause the processor to apply a clustering model to cluster the plurality of historical tickets in the plurality of clusters.

8. The system of claim 1 wherein the instructions, when executed, cause the processor to select the plurality of historical tickets based on a set of domain-specific parameters, wherein the selected plurality of historical tickets have a similar problem defined by the set of domain-specific parameters.

9. The system of claim 1, wherein the response output identifies common response steps of the one or more historical response steps of the historical tickets in the similar cluster.

10. The system of claim 1, wherein the instructions, when executed, cause the processor to determine semantic similarities of the one or more historical response steps, and generate the response output to identify the one or more historical response steps in an order that is based on the semantic similarities.

11. A computer-implemented method, comprising:
receiving a plurality of historical tickets each including at least one text field;
applying an embedding model to generate an embedding for each historical ticket in the plurality of historical tickets;
clustering the plurality of historical tickets in a plurality of clusters;
for each cluster of the plurality of clusters:
extracting one or more keywords from the at least one text field of each historical ticket in the cluster; and
generating at least one cluster-specific feature embedding including an entry for each of the one or more keywords;
receiving a ticket;
generating at least one feature embedding for the ticket;
determining a similar cluster for the ticket based on similarity between the at least one feature embedding for the ticket and the at least one cluster-specific feature embedding for each cluster in the plurality of clusters;
applying a first generative model to generate one or more ticket response steps for the ticket based on one or more historical response steps of each historical ticket in the similar cluster; and
applying the first generative model to generate a response output for the ticket by grouping the one or more ticket response steps based on similarity.

12. The computer-implemented method of claim 11, comprising:
applying a second generative model that summarizes the at least one text field of each historical ticket in the plurality of historical tickets; and
applying the embedding model to the summaries to generate the embedding for each historical ticket in the plurality of historical tickets.

13. The computer-implemented method of claim 11, comprising:
extracting at least one keyword from a text field of the ticket; and
generating the at least one feature embedding for the ticket based on the at least one keyword.

14. The computer-implemented method of claim 13, comprising:
applying a feature matrix model to the at least one keyword to generate a ticket matrix, wherein the ticket matrix comprises the at least one feature embedding for the ticket;
applying the feature matrix model to the embedding for each historical ticket in the plurality of historical tickets to generate a corresponding cluster matrix, wherein each cluster matrix comprises the at least one cluster-specific feature embedding for each corresponding cluster in the plurality of clusters; and
determining the similar cluster for the ticket based on a comparison of the ticket matrix to the cluster matrix for each corresponding cluster in the plurality of clusters.

15. The computer-implemented method of claim 14, comprising applying a similarity process to the ticket matrix and the cluster matrix for each corresponding cluster in the plurality of clusters to determine the similar cluster.

16. The computer-implemented method of claim 15, comprising determining the similar cluster based on the similarity process having a predetermined value.

17. The computer-implemented method of claim 11, comprising applying a clustering model to cluster the plurality of historical tickets in the plurality of clusters.

18. A non-transitory computer-readable medium having instructions stored thereon that, when executed by a processor, cause the processor to:
receive a plurality of historical tickets each including at least one text field;
apply an embedding model to generate an embedding for each historical ticket in the plurality of historical tickets;
cluster the plurality of historical tickets in a plurality of clusters;
for each cluster of the plurality of clusters:
extract one or more keywords from the at least one text field of each historical ticket in the cluster; and
generate at least one cluster-specific feature embedding including an entry for each of the one or more keywords;
receive a ticket including at least one text field;
generate at least one feature embedding for the ticket;
determine a similar cluster of historical tickets for the ticket based on similarity between the at least one feature embedding for the ticket and at least one cluster-specific feature embedding for each of a plurality of clusters of historical tickets;
apply a first generative model to generate one or more ticket response steps for the ticket based on one or more historical response steps of each historical ticket in the similar cluster of historical tickets; and
apply the first generative model to generate a response output for the ticket by grouping the one or more ticket response steps based on similarity.

19. The non-transitory computer-readable medium of claim 18 wherein the instructions, when executed, cause the processor to:
apply a second generative model that summarizes the at least one text field of each historical ticket in the plurality of historical tickets; and
apply the embedding model to the summaries to generate the embedding for each historical ticket in the plurality of historical tickets.

20. The non-transitory computer-readable medium of claim 18 wherein the instructions, when executed, cause the processor to:
extract at least one keyword from a text field of the ticket; and
generate the at least one feature embedding for the ticket based on the at least one keyword.
